(19) United States
(12) Patent Application Publication
(10) Pub. No.: US 2025/0389967 A1
(43) Pub. Date: Dec. 25, 2025

(54) HEAD WORN DISPLAY (HWD) OPTICAL ASSEMBLY WITH WAVEGUIDE EMBEDDED IMAGING AND ILLUMINATION

(71) Applicant: Rockwell Collins, Inc., Cedar Rapids, IA (US)

(72) Inventors: Andrew E. Warner, Tualatin, OR (US); Francois Raynal, Wilsonville, OR (US); Brock A. Macknick, Puyallup, WA (US)

(21) Appl. No.: 18/749,214

(22) Filed: Jun. 20, 2024

(51) Int. Cl. G02B 27/01

(52) U.S. Cl. CPC G02B 27/0179; G02B 27/0172; G02B 2027/0187

(57) ABSTRACT

A system and method for eye tracking via a head worn display (HWD), helmet mounted display (HMD) or other wearable display device provides an optical path of one or more optical elements for directing a display image into a display surface, which reflects the image into an eye location for viewing by a user or wearer of the display. An illuminator is optically coupled into the optical path via illuminator waveguides such that luminous output is vectored along the optical path, reflecting off the display surface and illuminating the wearer’s eye for imaging. Similarly, a camera is vectored into the same optical via imaging waveguides such that the camera may capture ocular images of the illuminated eye reflected off the display surface and directed via the optical path, but in the opposite direction. In this way the illuminator and camera may be incorporated into the optical path without obstructing it.

### GOVERNMENT SUPPORT

This technology was developed with U.S. government support under contract number HQ0727-16-D-0006 awarded by the Defense Microelectronics Activity (DMEA). The U.S. government has certain rights in this invention.

### BACKGROUND

Physiological monitoring of pilots who wear helmets (e.g., for fatigue, alertness, responsiveness) requires tracking and sensor solutions capable of integration into the helmet. For example, incorporating eye trackers (e.g., gaze trackers) into a head-worn display (HWD) or helmet mounted display (HMD) requires careful placement of tracking sensors to ensure good data is captured. However, limited space provided within the helmet assembly, in addition to off-axis eye viewing, severely constrain installation options for image sensor (e.g., camera) and lighting placement without obstructing the display path.

### SUMMARY

In a first aspect, an optical assembly for a wearable display device (e.g., a head worn display (HWD)) is disclosed. In embodiments, the optical assembly includes a display source for generating an image for presentation to the wearer or user of the device. The device includes a support structure for supporting the display device (e.g., via the user’s head, temples, etc.), the support structure wearable by the user. The device includes a display surface via which the generated image is reflected into an eye location for viewing by the user. The generated image is projected along an optical path including one or more lenses, waveguides, and/or other optical elements for projecting the display image from the display source toward the display surface. The device includes an illuminator outside the optical path and vectored into the optical path by at least one illuminator waveguide, such that the illuminator output is (similarly to the display image) projected along the optical path and reflected off the display surface into the user’s eye. The device includes a camera or other image sensor also disposed outside the optical path and also vectored into the optical path by one or more imaging waveguides, such that the camera captures an image of the illuminated eye via the optical path, but in the opposite direction (e.g., reflected off the display surface and into the optical path).

In some embodiments, the display device is a helmet mounted display (HMD) and the support structure is a helmet wearable by the user.

In some embodiments, the display surface is a visor of the helmet (e.g., an interior surface of the visor).

In some embodiments, the optical path has a first end proximate or adjacent to the display source and a second or opposite end proximate to the display surface.

In some embodiments, the illuminator waveguide/s and imaging waveguide/s are optically vectored into the optical path at either the first end or the second end of the optical path.

In some embodiments, the illuminator waveguides are incorporated into a cap attachable to and detachable from the second end of the optical path.

In some embodiments, the illuminator is also incorporated into the cap.

In some embodiments, the imaging waveguides are incorporated into a cap attachable to and detachable from the second end of the optical path.

In some embodiments, the camera is also incorporated into the cap.

In some embodiments, both the illuminator and imaging waveguides are incorporated into a cap attachable to and detachable from the second end of the optical path.

In some embodiments, the illuminator and camera are also incorporated into the cap.

In some embodiments, the illuminator waveguide/s and imaging waveguide/s are disposed at opposite ends of the optical path.

In some embodiments, either or both of the illuminator waveguide/s and imaging waveguide/s are vectored into the optical path between the first and second ends.

In some embodiments, the illuminator waveguide/s and imaging waveguide/s are both vectored into the optical path at different points between the first and second ends of the path.

In some embodiments, the illuminator emits output in the near-infrared (nIR) range.

In a further aspect, a method for eye tracking via an optical assembly is also disclosed. In embodiments, the method includes providing a display image for presentation to a wearer (user) of a head worn display (HWD) device via a display source attached to the HWD. The method includes positioning the display image on a display surface of the HWD by projecting the display image along an optical path in a direction (vector) from the display source to the display surface. The method includes reflecting the display image, via the display surface, into an eye location for viewing by the wearer. The method includes providing a luminous output via an illuminator positioned outside the optical path. The method includes vectoring the luminous output into the optical path via one or more illuminator waveguides optically connecting the illuminator and the optical path. The method includes reflecting the luminous output into the eye location via the display surface (e.g., to illuminate the eye of the wearer). The method includes capturing an ocular image of the illuminated eye via a camera or image sensor positioned outside the optical path but vectored into the optical path via one or more imaging waveguides optically connecting the camera to the optical path, such that the ocular image is reflected off the display surface and captured by the camera via the optical path, but in a direction opposite the projection of the display image and the luminous output.

In some embodiments, the HWD is a helmet-mounted display (HMD).

In some embodiments, the display surface is a visor of the HMD.

In some embodiments, the illuminator is a near-infrared (nIR) emitter providing luminous output in the nIR range.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples ("examples") of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a diagrammatic illustration illustrating a relay optic assembly (ROA) with embedded imaging and illumination according to example embodiments of this disclosure; and

FIG. 2 is a diagrammatic illustration illustrating an alternative implementation of the ROA of FIG. 1;

FIG. 3 is a diagrammatic illustration illustrating an alternative implementation of the ROA of FIG. 1; and

FIGS. 4A and 4B are process flow diagram illustrating a method for eye tracking via an ROA according to example embodiments of this disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination or sub-combination of two or more such features, along with any other features which may not necessarily be expressly described or inherently present in the instant disclosure.

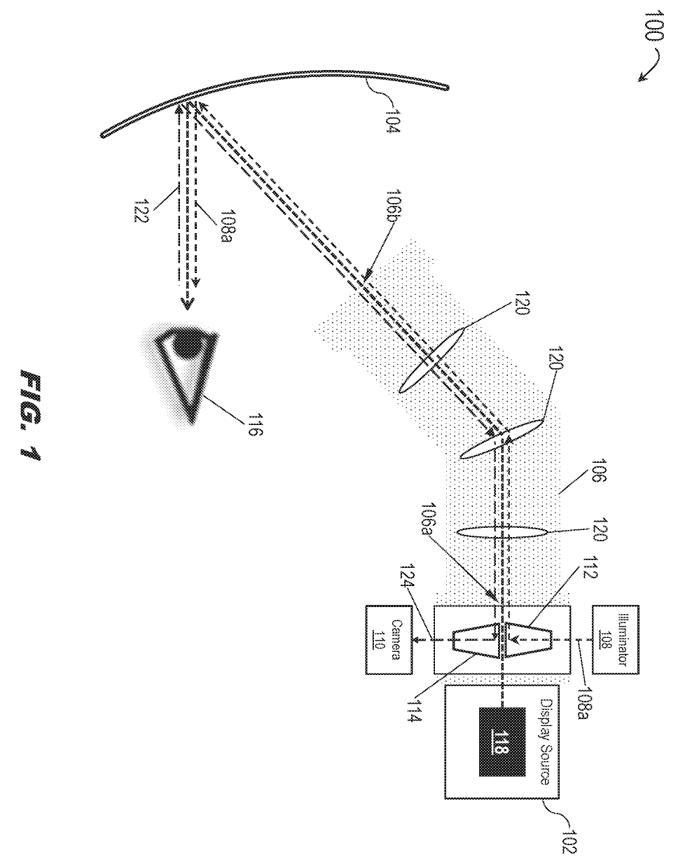

Referring now to FIG. 1, an optical assembly 100 for a wearable display device (e.g., head worn display (HWD), helmet mounted display (HMD)) is disclosed. The optical assembly 100 may include a display source 102, display surface 104, optical path 106, illuminator 108, camera 110 (e.g., image sensor), illuminator waveguide/s 112, and imaging waveguide/s 114.

In embodiments, the optical assembly 100 may be mounted to a wearable support structure and/or frame enabling the wearer or user to support the wearable display device proximate to their eye/s 116. For example, the wearable display device may be a helmet mounted display (HMD) or other like head worn display (HWD) wherein the optical assembly 100 is integrated into a helmet worn by the user. Further, the display surface 104 may be an interior surface of a visor of the helmet. In some embodiments, the wearable display device is integrated into a pair of eyeglasses, goggles, or other appropriate eyewear (e.g., and supported by an eyewear frame supportable by the wearer’s ears and/or nose).

In embodiments, the wearable display device, and thus the optical assembly 100, may be configured to fit the wearer/user such that display images 118 generated by the display source 102 (e.g., a graphics generation processor, enhanced vision system (EVS), synthetic vision system (SVS), combined vision system) are reflected off the display surface 104 into an optimal location for viewing by the wearer’s eye 116. For example, the optical assembly 100 may be calibrated based on the wearer’s interpupillary distance (IPD), or the distance between the centers of the user’s left and right pupils.

In embodiments the optical assembly 100 may include an optical path 106 (e.g., optical chain) optical path 106 via which the display image 118 is projected against the display surface 104 at an optimal angle for reflection into the user’s eye 116 (e.g., in a first direction from the display source 102 toward the display surface). For example, the optical path 106 may include a single optical element or a serial or sequential arrangement of two or more individual optical elements 120 (e.g., lenses, waveguides, combiners) arranged such that the display image 118 is vectored or otherwise directed along the optical path 106 in the first direction. Further, the optical path 106 may refer generally to a path extending between an initial end 106a (e.g., adjacent to the display source 102) and a terminal end 106b (e.g., where the projected display image 118 leaves the optical path 106 and is projected against the display surface 104), the first direction extending from the initial end toward the terminal end.

In embodiments, the optical assembly 100 may include a camera 110 (e.g., image sensor, image capture device) for capturing an ocular image 122 (an image of the eye 116 indicative of the gaze direction and/or orientation of the eye) and one or more illuminators 108 for providing a baseline amount of luminous output to allow the capture of clear, detailed ocular images by the image sensor. For example, the illuminator/s 108 may be a near-infrared (nIR) emitter providing a nIR luminous output (e.g., at wavelengths between 700 nm and 2500 nm, particularly ~850 nm) that, while outside the visible light spectrum (and therefore not detrimental to the viewing of display images 118), provides clear demarcation of the pupil and iris with respect to ocular images 122 captured by the camera 110.

In embodiments, the optical assembly 100 may integrate the illuminator 108 and camera 110 without obstructing the optical path 106 via the illuminator waveguide/s 112 and imaging waveguide/s 114. For example, the illuminator 108 and camera 110 may both be disposed outside the optical path 106. Further, the illuminator waveguide/s 112 may include diffraction gratings or any other appropriate waveguides configured to vector the luminous output 108a of the illuminator 108 into the optical path without obstructing the optical path. Accordingly, the luminous output 108a may likewise be vectored through the optical path 106 by the optical elements 120 in the first direction (e.g., from the initial end 106a toward the terminal end 106b), projected at the display surface 104, and reflected off the display surface into the eye 116 (e.g., at the same angle as the display image/s 118).

In embodiments, the imaging waveguide/s 114 may likewise connect the camera 110 into the optical path 106 without obstructing the optical path. For example, similarly to the illuminator waveguide/s 112, the imaging waveguide/s 114 may connect the camera to the optical path 106. Further, the camera 110 may capture ocular images 122 reflected by the display surface 104 into the optical path 106 and vectored by the optical elements 120 in a second direction, (e.g., opposite the first direction; from the display surface 104/terminal end 106b toward the display source 102/initial end 106a), through the imaging waveguide/s 114, and into the camera.

In embodiments, as the optical assembly 100 integrates the illuminator/s 108 and camera 110 into the optical path 106 (without obstructing the optical path), integrating the wearable display device into the helmet and/or eyewear is made considerably less complex. For example, the illuminator 108 and camera 110 are already aligned with the optical assembly 100, and the optical path 106 may shift with the optical assembly 100 (e.g., based on changes in the wearer’s IPD position), so only the optical path 106 need be correctly oriented and calibrated with respect to the helmet and/or eyewear.

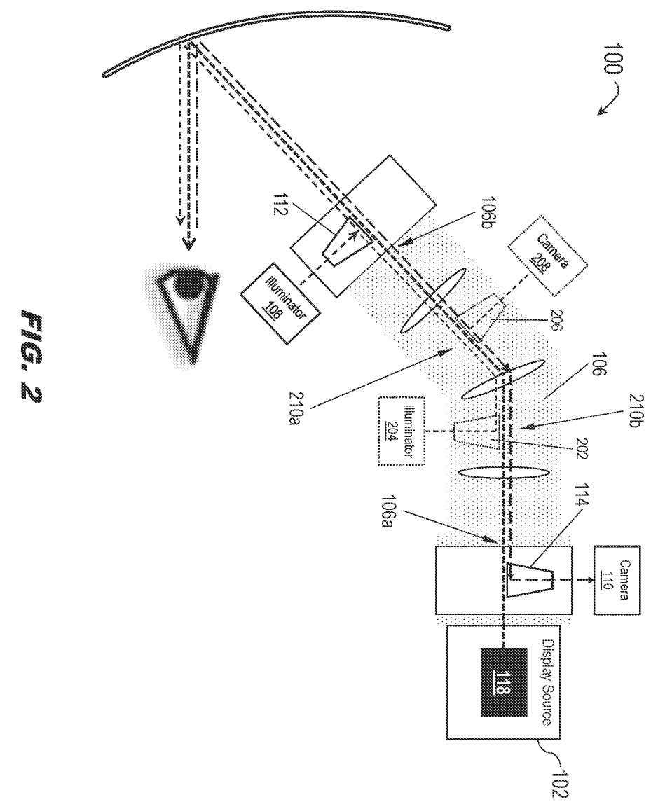

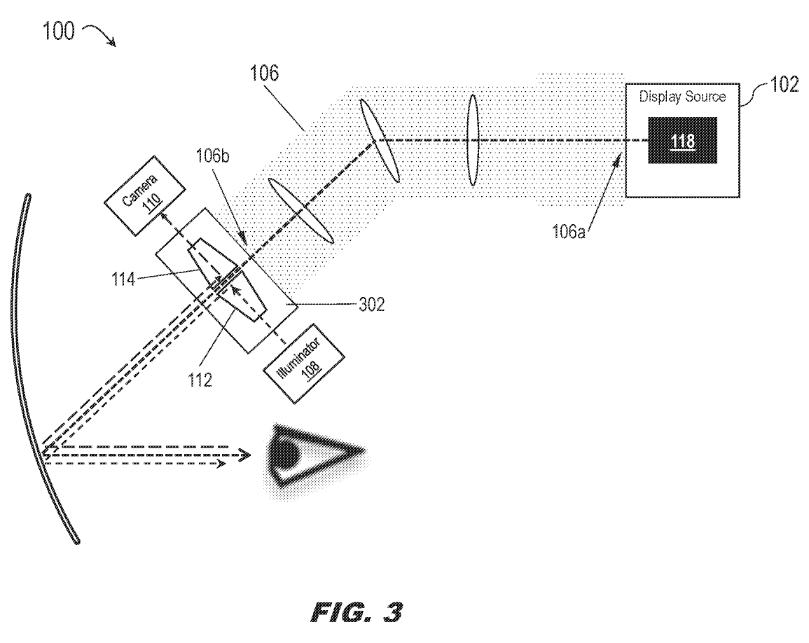

Referring now to FIGS. 2 and 3, the optical assembly 100 is shown.

In embodiments, the illuminator waveguide/s 112 an/or imaging waveguide/s 114 may be disposed elsewhere within the optical path 106 so long the optical path 106 is unobstructed. For example, referring in particular to FIG. 2, the imaging waveguide/s 114 may be disposed at the initial end 106a of the optical path 106 (e.g., proximate or adjacent to the display source 102) while the illuminator waveguide/s 112 may be disposed at the terminal end 106b of the optical chain. In embodiments, the illuminator waveguide/s 112 and/or imaging waveguide/s 114 may be disposed anywhere in the optical path 106 so long as the illuminator and imaging waveguides are oriented to vector the illuminator 108 and camera 110 into the optical path 106. For example, the optical assembly 100 may include illuminator waveguide/s 202 and/or an illuminator 204 disposed in the optical path 106 between the initial end 106a and the terminal end 106b. Similarly, the optical assembly may include imaging waveguide/s 206 and/or a camera 208 disposed between the initial and terminal ends 106a, 106b of the optical path 106. In some embodiments, the illuminator waveguide/s 202 and imaging waveguide/s 206 are disposed at different points 210a, 210b between the initial and terminal ends 106a, 106b.

Similarly, referring in particular to FIG. 3, in some embodiments both the illuminator waveguide/s 112 and imaging waveguide/s 114 may be disposed at or near the terminal end 106b of the optical path 106. For example, the illuminator 108/illuminator waveguide/s 112 and camera 110/imaging waveguide/s 114 may be incorporated into a cap 302 attachable to (and detachable from) the optical path 106 at the terminal end 106b of the optical path 106. In embodiments, the illuminator 108 and/or camera 110 incorporated into the attachable/detachable cap 302 may communicate via wireless link or physical link (e.g., completed by the attachment of the cap via pins or other like connectors) with the HWD or HMD.

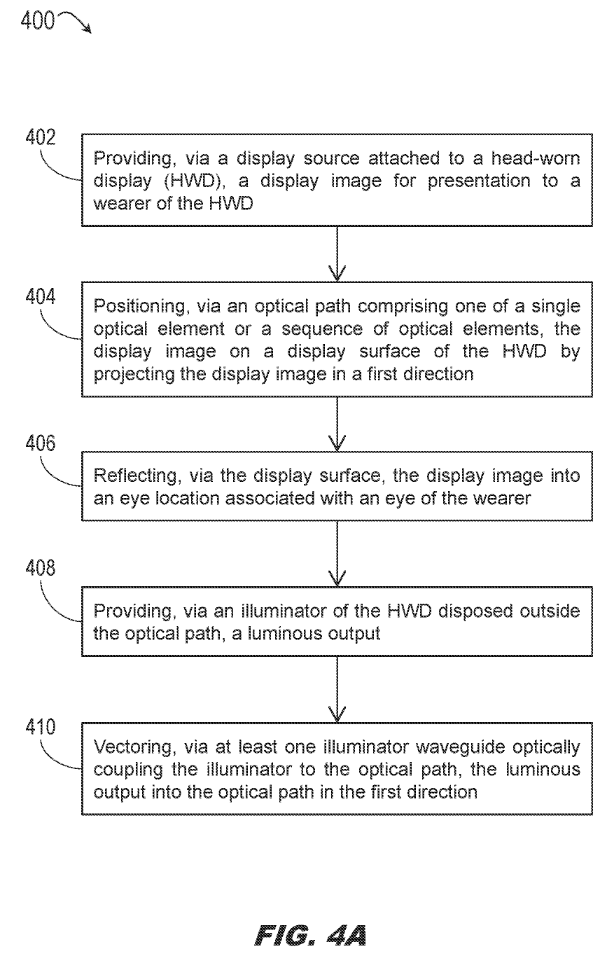

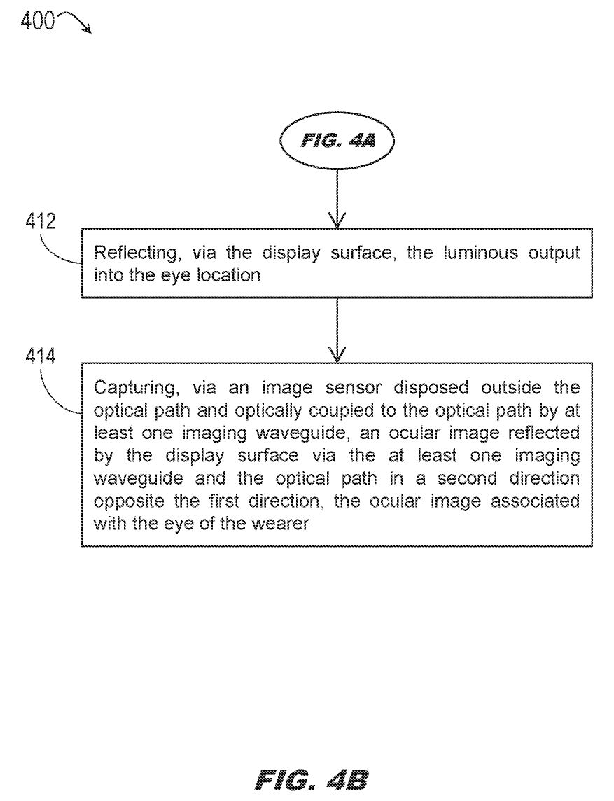

Referring now to FIG. 4A, the method 400 may be implemented by the optical assembly 100 and may include the following steps.

At a step 402, a display source attached to a head worn display (HWD) or helmet mounted display (HMD) provides a display image for presentation to the HWD/HMD wearer/user.

At a step 404, the display image is positioned on a display surface of the HMD/HWD via an optical path comprising a single optical element or a sequence, series, or chain of optical elements (e.g., lenses, waveguides, diffraction gratings, combiners). For example, the optical path directs or vectors the display image in a first direction through the optical element/s, e.g., from the display source toward the display surface. In some embodiments, the display surface is a visor of a helmet into which the HMD is incorporated. In some embodiments, the display surface is an interior surface of a lens, e.g., wherein the head worn display is incorporated into a pair of goggles, glasses, or other like eyewear.

At a step 406, the display surface reflects the display image into an eye location for viewing by the wearer/user. For example, the optical element/s may project the display image into the display surface at such an angle that the display image is reflected into an optimal location for viewing by the wearer’s eye.

At a step 408, an illuminator of the HMD/HWD disposed outside the optical path provides a luminous output. In some embodiments, the illuminator is a near-infrared (nIR) illuminator.

At a step 410, one or more illuminator waveguides connecting the illuminator with the optical path vectors the luminous output into the optical path, e.g., toward the display surface, in the first direction.

Referring also to FIG. 4B, at a step 412, the display surface reflects the luminous output into the eye location, illuminating the eye.

At a step 414, a camera or other image sensor disposed outside the optical path, the camera connected to the optical path via one or more imaging waveguides, captures an ocular image (e.g., an image of the illuminated eye) reflected by the display surface via the imaging waveguide/s and the optical path but in a second direction opposite the first direction, e.g., from the display surface toward the display source, and into the camera.

### BENEFITS OF THE INVENTION

Embodiments of the inventive concepts disclosed herein may significantly reduce the complexity and/or weight associated with optical tracking and/or monitoring integration into the HMD/HWD. For example, when the camera/s and illuminator/s are vectored into the optical path, alignment or calibration of the camera/s and illuminator/s is not necessary; only the optical path must be aligned in the proper position/orientation within the HMD/HWD. Similarly, as the optical path shifts with the IPD position of a given user, customization of the HMD/HWD for that user is simplified as no additional customization of lighting or imaging elements is required.

### CONCLUSION

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

We claim:

1. An optical assembly for a wearable display device, comprising:
a display source configured to generate a display image;
a support structure wearable by a user;
a display surface configured to reflect the display image into an eye location associated with an eye of the user;
an optical path comprising either a single optical element or a sequence of two or more optical elements, the optical path configured to direct the display image in a first direction from the display source toward the display surface;
at least one illuminator disposed outside the optical path, the at least one illuminator optically coupled to the optical path via at least one illuminator waveguide, the at least one illuminator waveguide configured to vector an output of the at least one illuminator into the optical path to be reflected by the display surface into the eye location;
and
an image sensor disposed outside the optical path, the image sensor optically coupled to the optical path via at least one imaging waveguide, the image sensor configured to capture an ocular image from the display surface via the at least one imaging waveguide and the optical path in a second direction opposite the first direction.

2. The optical assembly of claim 1, wherein the support structure includes a helmet wearable by the user.

3. The optical assembly of claim 2, wherein the display surface is associated with a visor of the helmet.

4. The optical assembly of claim 1, wherein the optical path extends between a first end adjacent to the display source and a second end proximate to the display surface.

5. The optical assembly of claim 4, wherein:
the at least one illuminator waveguide and the at least one imaging waveguide are optically coupled to the optical path at one of the first end or the second end.

6. The optical assembly of claim 5, wherein the at least one illuminator waveguide is incorporated into a cap attachable to and detachable from the second end.

7. The optical assembly of claim 6, wherein the at least one illuminator is incorporated into the cap.

8. The optical assembly of claim 5, wherein the at least one imaging waveguide is incorporated into a cap attachable to and detachable from the second end.

9. The optical assembly of claim 8, wherein the image sensor is incorporated into the cap.

10. The optical assembly of claim 5, wherein the at least one imaging waveguide and the at least one illuminator waveguide are incorporated into a cap attachable to and detachable from the second end.

11. The optical assembly of claim 10, wherein the at least one illuminator and the image sensor are incorporated into the cap.

12. The optical assembly of claim 4, wherein:
the at least one illuminator waveguide is optically coupled to the optical path at one of the first end or the second end;
and
wherein the at least one imaging waveguide is optically coupled to the optical path at the other of the first end or the second end.

13. The optical assembly of claim 4, wherein one or more of the at least one illuminator waveguide and the at least one imaging waveguide are optically coupled to the optical path between the first end and the second end.

14. The optical assembly of claim 13, wherein the at least one illuminator waveguide and the at least one imaging waveguide are optically coupled to the optical path at different points between the first end and the second end.

15. The optical assembly of claim 1, wherein the at least one illuminator includes a near-infrared (nIR) emitter.

16. A method for eye tracking via an optical assembly, the method comprising:
providing, via a display source attached to a head-worn display (HWD), a display image for presentation to a wearer of the HWD;
positioning, via an optical path comprising one of a single optical element or a sequence of optical elements, the display image on a display surface of the HWD by projecting the display image in a first direction;
reflecting, via the display surface, the display image into an eye location associated with an eye of the wearer;
providing, via an illuminator of the HWD disposed outside the optical path, a luminous output;
vectoring, via at least one illuminator waveguide optically coupling the illuminator to the optical path, the luminous output into the optical path in the first direction;
reflecting, via the display surface, the luminous output into the eye location;
and
capturing, via an image sensor disposed outside the optical path and optically coupled to the optical path by at least one imaging waveguide, an ocular image reflected by the display surface via the at least one imaging waveguide and the optical path in a second direction opposite the first direction, the ocular image associated with the eye of the wearer.

17. The method of claim 16, wherein the HWD is a helmet-mounted display (HMD).

18. The method of claim 17, wherein the display surface is associated with a visor of the HMD.

19. The method of claim 16, wherein providing, via an illuminator of the HWD disposed outside the optical path, a luminous output includes:
providing, via a near-infrared (nIR) emitter disposed outside the optical path, a near-infrared luminous output.
